(19) United States
(12) Patent Application Publication
(10) Pub. No.: US 2003/0223396 A1
(43) Pub. Date: Dec. 4, 2003

(54) Method of indicating the forward link serving sector in high data rate CDMA systems

(76) Inventors: Shiau-He Shawn Tsai, San Diego, CA (US); Seong-Jun Oh, San Diego, CA (US); Patrik Nils Lundqvist, Encinitas, CA (US)

Correspondence Address: COATS & BENNETT, PLLC, P O BOX 5, RALEIGH, NC, 27602, US

(21) Appl. No.: 10/160,961

(22) Filed: May 31, 2002

(51) Int. Cl. H04B 7/216

(52) U.S. Cl. 370/342; 370/335

(57) ABSTRACT

A mobile terminal for CDMA systems has multiple operating states including an active state and a control hold state. In the active state the mobile terminal transmits an pilot signal on a pilot channel and rate control information on a reverse rate control channel. In the active state a sector selection code is applied to the reverse rate control channel to indicate selection of a serving base station for forward link communications. In the control hold state, the mobile terminal transmits a pilot signal covered by a sector selection code. The pilot signal may be gated, i.e., transmitted at a reduced duty cycle, in the control hold mode. The pilot signal may be transmitted on either the reverse pilot channel or the reverse rate control channel. Transmission on the other channel is suspended in the control hold state.

### BACKGROUND OF THE INVENTION

The present invention relates generally to CDMA communication systems and, more particularly, to methods of indicating selection of a forward link serving sector in high data rate CDMA systems.

Numerous access schemes exist to allow multiple users to share a communication medium. One such access scheme is known as Code Division Multiple Access (CDMA). In CDMA systems, multiple users share the same carrier frequency and may transmit simultaneously. Each user has its own pseudo-noise (PN) sequence, which is approximately orthogonal to the PN sequences of other users. Transmissions to or from individual users are imprinted with that user's PN sequence. The receiver selects the desired signal, which combines in the communication with unwanted signals, by correlating the received signal with the PN sequence of the desired signal. All other signals are spread by the PN sequence and appear as noise to the receiver.

The current standard for CDMA systems in the United States is contained in a specification published by the Telecommunications Industry Association and Electronics Industry Association (TIA/EIA), known as IS-95. New standards for wideband CDMA are currently being developed in North America, Europe and Japan, which offer significant performance improvements compared to the current CDMA standard. One such standard is known as cdma2000. cdma2000 is a wideband, spread-spectrum radio interface that uses CDMA technology to satisfy the needs of third generation wireless communication systems. Several enhancements of the cdma2000 standard have been proposed to facilitate the gradual evolution of third generation wireless communication systems. The cdma2000 variant known as 1xEV-DO is being developed to provide high-speed packet data services as an overlay to existing circuit-switched networks. The next step in the evolution of the cdma2000 technology is the variant known as 1xEV-DV. Networks implementing this standard will provide circuit-switched voice and data as well as packet-switched high-speed data on the same carrier.

CDMA systems are interference-limited systems. Since all mobile terminals operate at the same frequency, internal interference generated within the system plays a critical role in determining system capacity and voice quality. The transmit power from each mobile terminal must be controlled to limit interference while maintaining desired performance objectives, e.g., bit error rate (BER), frame error rate (FER), capacity, dropped-call rate, coverage, etc.

Two closely related techniques used in CDMA systems to reduce interference are power control and soft handoffs. Power control is used on the reverse link in CDMA systems to control the power of signals received at each base station from the mobile terminals. The purpose of power control is to assure that each mobile terminal served by a particular base station provides approximately the same signal level to the receiver at that sector. In CDMA systems, the system capacity is maximized if the transmit power level of each mobile terminal is controlled so that its signals arrive at the base station receiver with the minimum required signal-to-noise ratio (SNR) or signal-to-interference ratio (SIR). The target value for the received power level is the minimum level possible that allows the link to meet the predetermined performance objectives.

Another technique used in CDMA communication systems to reduce interference is known as a soft handoff. A handoff is the act of transferring support for a mobile terminal from one sector or cell to another when the mobile terminal moves between sectors or cells. In a traditional “hard” handoff, the connection to the current base station is broken and a connection is made with the new base station to resume communication with the mobile terminal. This is known as a “break before make” handoff. Because all sectors in a CDMA system use the same frequency, it is possible to make the connection to the new base station before terminating the connection with the current base station. This is known as a “make before break” or “soft” handoff. A soft handoff requires less power, which reduces interference and increases system capacity. During soft handoff, each base station participating in the handoff receives transmissions from the mobile terminal over its assigned code channel. The base stations receiving transmissions from the same mobile terminal are referred to as the active set for the mobile terminal.

In high data rate CDMA systems, such as 1xEV-DV and 1xEV-DO systems, the forward link is time-multiplexed and transmitted at the full power available to the base station, but with data rates and slot times that vary depending on downlink channel conditions. The data rate that can be supported by the downlink is proportional to the SNR, which changes continuously. The mobile terminal measures the instantaneous signal to noise ratio (SNR) of the pilot signal received from each base station in its active set and requests service from the base station providing the strongest signal. The mobile terminal transmits the SNR value, or equivalently the supportable data rate, for the base station providing the strongest signal on a reverse control channel referred to herein as the rate control channel. The mobile terminal also identifies the selected forward link base station by applying a Walsh cover to the rate control channel. Because each base station has a unique Walsh cover, the base station that receives the rate control channel knows that it has been selected by the mobile terminal to provide data on the forward link. This process is known as sector selection.

In 1xEV-DV systems, the mobile terminal transmits the SNR or other channel quality indicator (CQI) data to the selected forward link base station on a channel known as the Reverse Channel Quality Indicator Channel (R-CQICH). In 1xEV-DO systems the mobile terminal transmits data rate requests to the selected base station on the Reverse Data Rate Channel (DRC). The mobile terminal applies a Walsh cover to the R-CQICH or DRC to indicate its selection of a serving base station for forward link communications.

In current implementations of cdma2000 systems, the R-PICH and R-CQICH or DRC are transmitted continuously. It has been proposed to reduce interference and hence increase system capacity by introducing a control hold control hold for mobile terminals with low transmit activity factors. In the control hold state, the mobile terminal suspends or reduces transmissions on many of the overhead channels, such as the RPICH and R-CQICH. Gating or suspending transmission on the R-PICH and R-CQICH reduces interference on the reverse link, thus increasing the reverse link throughput and capacity. It also results in lower power consumption at the mobile terminal and thus increased battery life.

Gating the reverse link channels, however, degrades the performance of the CDMA system closed loop power control, as power measurements and power adjustment commands are performed less frequently. More particularly, gating increases the carrier/interference (C/I) standard deviation because of slower power control. Continuing to transmit absolute CQI data on R-CQICH with high C/I standard deviation is not efficient, particularly as the mobile speed increases. The CQI data may be sent differentially, but this may cause a large CQI tracking error. In short, inefficiencies caused by sending CQI data on a gated reverse link can offset the gain of gating the reverse links at all. Turning off the R-CQICH during the control hold state is undesirable because the R-CQICH is used by the mobile terminal to indicate the serving base station on the forward link. Also, if the R-CQICH is turned off, the network would need to signal the transition back to the active state through all the base stations in the active set in order ensure that the mobile terminal receives the signal. This signaling would also delay return to the active state.

### SUMMARY OF THE INVENTION

The present invention relates to mobile terminal operation in a control hold state in a high data rate CDMA system. The invention is useful, for example, in systems implementing standards known as 1xEV-DV and 1xEV-DO where the forward link is rate-controlled and the mobile station must indicate its selection of a serving base station for forward link communications. In an active state, the mobile terminal according to the present invention transmits a pilot signal on a reverse pilot channel (R-PICH) and transmits rate control information on a reverse rate control channel, i.e. the Reverse Channel Quality Indicator Channel (R-CQICH) for 1xEV-DV systems or the Reverse Data Rate Request Channel (DRC) for 1xEV-DO systems. Sector selection coding is applied to the rate control channel to indicate the serving base station for the forward link. In the control hold state, the mobile terminal transmits a pilot signal and applies the sector selection coding to the pilot signal to indicate the serving sector for the forward link. The pilot signal may also be gated, i.e., transmitted at a reduced duty cycle in the control hold state. Transmission of rate control information is suspended in control hold state.

In one embodiment, the mobile terminal continues transmitting the pilot signal on a reverse pilot channel and applies sector selection coding to the pilot signal in the control hold state. In this case, the mobile terminal suspends transmissions on the rate control channel. Alternatively, the pilot signal may be generated by blanking the rate control channel, that is, replacing the rate control information with all zeros or other null data, and suspending transmission of the R-PICH.

The present invention also relates to a method of indicating a transition from the control hold state to the active state by the mobile terminal. When the mobile terminal is in the control hold state, transmission on either the reverse pilot channel or the reverse rate control channel is suspended. The base station may therefore detect transition of the mobile terminal from the control hold state to the active state by detecting the energy level on the suspended channel.

### BRIEF DESCRIPTION OF DRAWINGS

FIG. 1 is a block diagram of a mobile communication network according to the present invention.

FIG. 2 is a functional block diagram of a mobile terminal in the mobile communication network of FIG. 1.

FIG. 3 is a functional block diagram of a base station in a mobile communication network.

FIG. 4 is a state diagram illustrating the operating states of the mobile terminal according to the present invention.

### DETAILED DESCRIPTION OF THE INVENTION

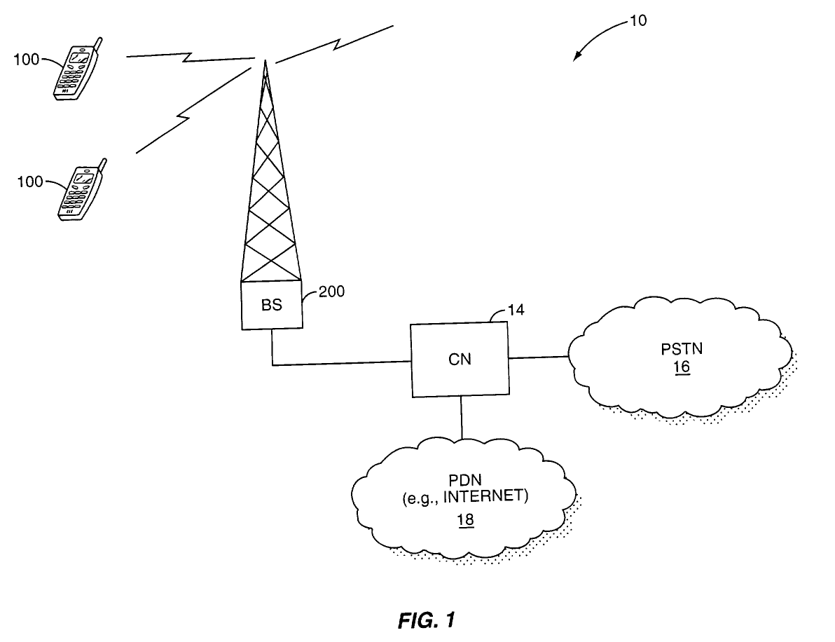

Referring now to FIG. 1, the present invention will be discussed in the context of a wireless communications network 10 supporting over-the-air communications between mobile terminals 100 and fixed stations generally known as base stations 12. Base stations 12 connect via a core network (CN) 14 to external wireline networks such as the Public Switched Telephone Network (PSTN) 16, the Integrated Services Digital Network (ISDN), and/or a Packet Data Network (PDN) 18, such as the Internet. Each base station 12 is located in and provides wireless communication services to a geographic region referred to as a cell, which may comprise one or more sectors. In general, there is one base station 12 for each cell or sector. A single base station may serve multiple sectors.

Within a sector, there may be a plurality of mobile terminals 100 that communicate via a radio link with a serving base station 12. The base station 12 allows the users of the mobile terminals 100 to communicate with other mobile terminals 100, or with users connected to the external network. The CN 14 routes calls to and from the mobile terminal 100 through the appropriate base station 12.

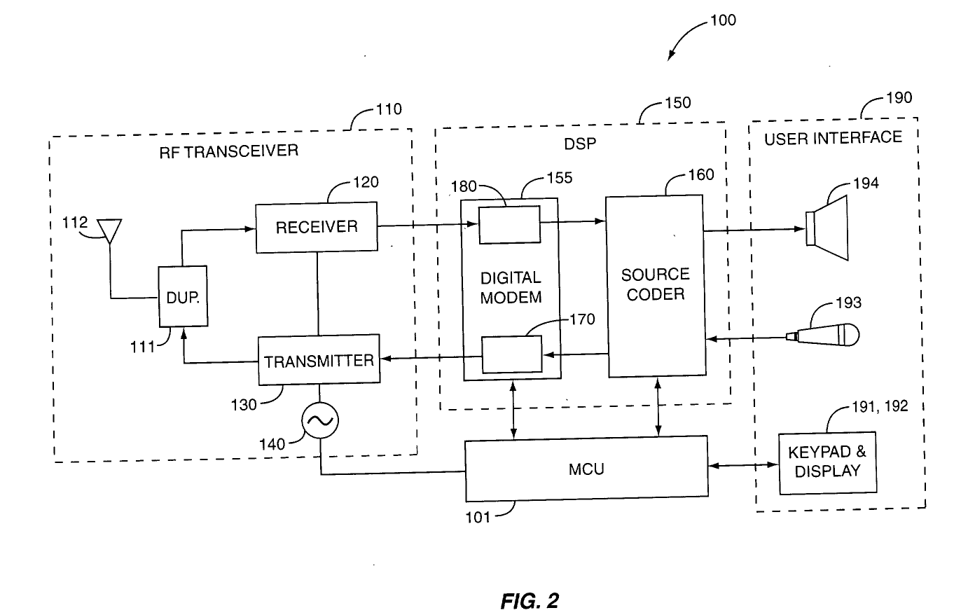

FIG. 2 is a block diagram of a mobile terminal 100. The term mobile terminal 100 as used herein includes a cellular radiotelephone; a Personal Digital Assistant (PDA) that may combine a cellular radiotelephone with data processing, facsimile and data communications capabilities; a conventional laptop and/or palmtop computer equipped with a radiotelephone transceiver, or other appliance that includes a radiotelephone transceiver. Mobile terminals 100 may also be referred to as “pervasive computing” devices.

Mobile terminal 100 is a fully functional mobile radio transceiver capable of transmitting and receiving signals over a RF channel. Exemplary standards that may be implemented by the mobile terminal 100 include, but are not limited to, TIA/EIA/IS-2000 and TIA/EIA/IS-856 standards. Mobile terminal 100 comprises a microcontroller unit (MCU) 101, a RF transceiver 110, a digital signal processor (DSP) 150, and a user interface 190. Mobile terminal 100 may additionally include an external interface for communication with a computer, local area network, or other device.

RF transceiver 110 establishes a link for wireless communications with the base station 12. RF transceiver 110 comprises a receiver 120, transmitter 130, frequency synthesizer 140, duplexer or switch 111, and antenna 112. Receiver 120 receives downlink or forward link communications from the base station 12. Receiver 120 amplifies and downconverts received signals to a baseband frequency for processing by the DSP 150. Signals converted by receiver 120 to the baseband frequency are referred to herein as baseband signals.

Transmitter 130 sends uplink or reverse link communications to the base station 12. Transmitter 130 receives baseband signals from the DSP 150, which the transmitter 130 amplifies and uses to modulate an RF carrier at a directed power level. Frequency synthesizer 140 provides the reference signals used for frequency translation in the receiver 120 and transmitter 130. Transmitter 130 includes a variable gain amplifier (VGA) that allows adjustment of the transmit power. The gain of the VGA is adjusted responsive to power control commands from the base station 12 as described below.

Receiver 120 and transmitter 130 are coupled to antenna 112 by duplexer or switch 111. Duplexer 111 includes a duplex filter to isolate the transmitter 130 from the receiver 120. The duplex filter combines a transmit-band filter and receiver-band filter to provide the necessary isolation between the two paths.

DSP 150 comprises a digital modem 155,and source coder 160. Source coder 160 includes a speech coder (not shown) for digitizing and coding speech for transmission on the reverse link to the base station 12. Additionally, the speech coder decodes speech signals received from the base station 12 and converts speech signals into audio signals that are output to speaker 194. CDMA systems use an efficient method of speech coding and error recovery techniques to overcome the harsh nature of the radio channel. One speech coding algorithm frequently used in CDMA systems is Code Excited Linear Predictor (CELP) speech coding. Speech is typically encoded at rates of 9.6 kilobits per second or 13.3 kilobits per second. The details of speech coding are not material to the invention and, therefore, are not explained in detail herein.

The digital modem 155 processes digital signals to make communication over the propagation channel more robust. Digital modem 155 includes a digital modulator 170 and at least one demodulator 180. The digital modulator 170 superimposes the message waveform onto a carrier for radio transmission using techniques that guard against fading and other impairments of the radio channel while attempting to maximize bandwidth efficiency. Modulator 170 may also perform channel coding and encryption if used. The digital demodulator 180 detects and recovers the transmitted message. It tracks the received signal, estimates received signal strengths, rejects interference, and extracts the message data from noisy signals. Demodulator 180 also performs synchronization, channel decoding, and decryption if used.

The MCU 101 supervises the operation of the mobile terminal 100 and administers the procedures associated with the applicable communication protocol. The MCU 101 implements the communication protocols used by the mobile terminal 100. The communication protocol specifies timing, multiple access approach, modulation format, frame structure, power level, as well as many other aspects of mobile terminal operation. The MCU 101 inserts signaling messages into the transmitted signals and extracts signaling messages, such as power control commands, from the received signals. MCU 101 acts on signaling messages received from the base station 12 as set forth in the communication protocol. When the user enters commands via the user interface 190, the commands are passed to the MCU 101 for action. The functions performed by the MCU 101 include sector selection and data rate control for the forward link, which are described in more detail below.

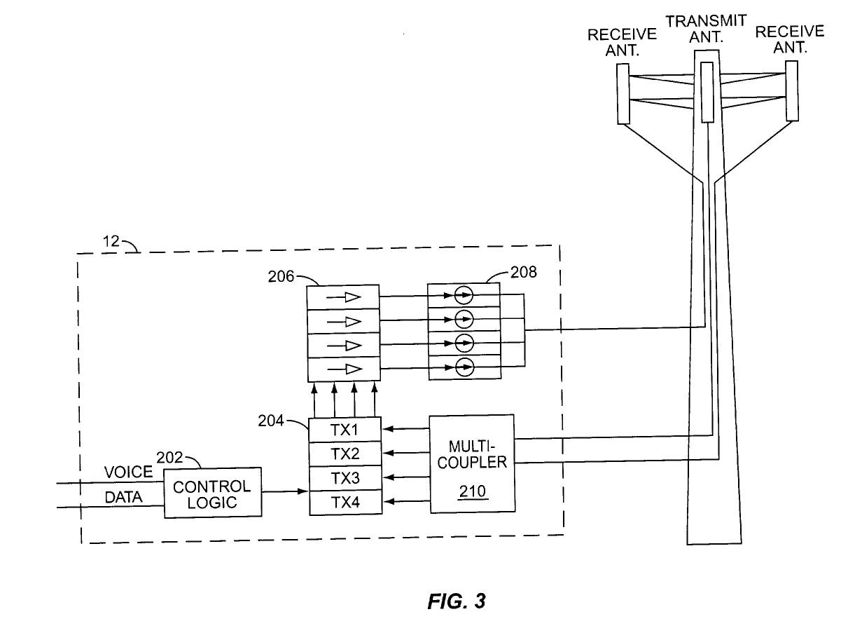

FIG. 3 is a functional block diagram of a base station 12. The base station 12 includes control logic 202, a transceiver array 204, amplifier array 206, RF combiner 208, and receive multicoupler 210. The transceiver array 202 comprises a plurality of transceivers, which may, for example, comprise CDMA transceivers. The transmitter outputs of the transceivers are supplied to a corresponding high power RF amplifier in the amplifier array 206. The RF combiner 208 allows separate radio channels to be combined onto one or more antennas without interfering with each other. The combined RF signal is routed to the transmitter antenna 212, typically via low energy loss coaxial cable. Receiver antennas 214 are connected to the RF multicoupler 210 via low loss coaxial cables. The multicoupler 210 splits the received signals into multiple channels for respective transceivers. The receiver portion of the transceiver converts the RF signal to baseband signals and processes the baseband signals.

The present invention was originally developed for use in CDMA networks and therefore the discussion will focus on CDMA communication networks 10 based on the cdma2000 standard. The present invention is particularly useful in systems based on the first EVolution (1xEV) of the cdma2000 standard, which includes both the 1xEV-DO (Data Only) and 1xEV-DV (Data and Voice) standards. However, the present invention could be adapted and employed in systems using other communication standards.

CDMA systems use soft handoff on the reverse link to reduce interference. In a traditional “hard” handoff, the connection to the current base station 12 is broken and a connection is made with the new base station 12 to resume communication with the mobile terminal 100. This is known as a “break before make” handoff. Because all base stations 12 in a CDMA system use the same frequency, it is also possible to make the connection to the new base station 12 before terminating the connection with the current base station 12. This is known as a “make before break” or “soft” handoff.

During soft handoff, each base station 12 participating in the handoff receives the signal on the reverse link from the mobile terminal 100. The participating base stations 12 are referred to as the active set for the mobile terminal 100. The mobile terminal transmit power is controlled by all of the base stations 12 in the active set. More particularly, each base station 12 participating in a soft handoff makes a separate determination of the power control bit (PCB) to be sent to the mobile terminal 100 based on pilot signal measurements. Each base station transmits a down bit or “1” to command the mobile terminal 100 to decrease its power on the reverse link, and transmits an up bit or “0” to command the mobile terminal 100 to increase its transmit power on the reverse link. The mobile terminal 100 processes the PCBs from the base stations 12 in its active set separately and performs an “or of the downs” logic operation. That is, if any of the base stations 12 transmits a “down” bit or “1”, the mobile terminal 100 reduces its transmit power. The net result is that the transmit power level of the mobile terminal 100 is reduced to the minimum level needed to be received by the base station 12 with the best reverse link. Thus, the soft handoff mechanism reduces interference in CDMA systems.

Soft handoff is not used on the forward link in high data rate CDMA systems, such as 1xEV-DV and 1xEV-DO systems. Instead, the forward link is time-multiplexed and transmitted at the full power available to the base station, but with data rates and slot times that vary depending on downlink channel conditions. The data rate that can be supported by the downlink is proportional to the SNR, which changes continuously. The mobile terminal 100 measures the instantaneous signal to noise ratio (SNR) of the pilot signal received from each base station in its active set and requests service from the base station 12 providing the strongest signal. The mobile terminal 100 transmits the SNR value, or equivalently the supportable data rate, for the base station 12 providing the strongest signal on a reverse control channel referred to generically herein as the rate control channel.

In 1xEV-DV systems, the mobile terminal 100 transmits the SNR or other channel quality indicator (CQI) data to the selected forward link base station 12 on a channel known as the Reverse Channel Quality Indicator Channel (R-CQICH). In 1xEV-DO systems the mobile terminal 100 transmits data rate requests to the selected base station 12 on the Reverse Data Rate Channel (DRC). The mobile terminal 100 applies a Walsh cover to the R-CQICH or DRC to indicate its selection of a serving base station 12 for forward link communications. For purposes of this application, the data transmitted by the mobile terminal 100 on the reverse rate control channels, e.g., the RCQICH and DRC, is referred to herein as rate control information because it is used by the base station 12 to determine the data rate for the forward link. The rate control information, as described above may comprise data rate requests, SNRs, CQI data, or other channel state information bearing on maximum data rate that may be supported by the forward link.

In high data rate CDMA systems, the mobile terminal 100 communicates its choice of base stations 12 to transmit on the forward link—its sector selection—by encoding the rate control channel with a sector selection code corresponding to the selected base station 12. Each base station 12 in the active set of a mobile terminal 100 is assigned a unique Walsh cover, which serves as a sector selection code. Therefore, the mobile terminal 100 indicates its selection of the forward link serving sector by applying the Walsh cover of the selected base station 12 to the rate control channel, e.g., the R-CQICH or DRC.

Using coherent reception, each base station 12 receives, demodulates, and decodes the rate control channel. When a currently non-serving base station 12 determines that it was selected it signals the base station controller. Also, when the current serving base station 12 detects that another base station 12 is selected, it signals the base station controller. The selected base station 12 uses the decoded rate control information from the rate control channel to adjust the data rate of the information transmitted to the mobile terminal 100 on the forward link and begins transmitting to the mobile terminal 100.

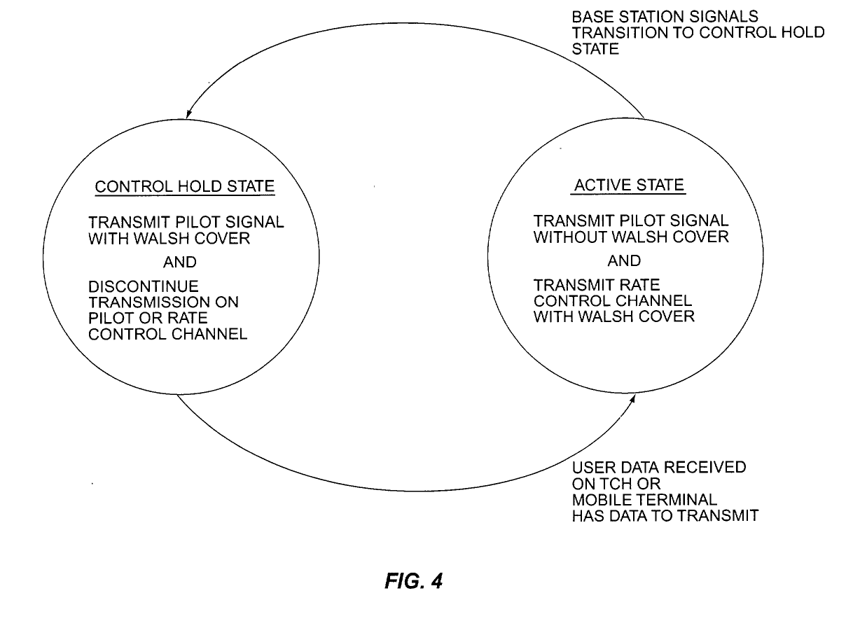

To reduce interference and hence increase system capacity, mobile terminals 100 with low transmit activity factors may enter a state referred to herein as the control hold state. For purposes of this application, the phrase control hold state means an operational state in which transmissions from the mobile terminal 100 are reduced as compared to a normal or active state of operation. Reduction in transmissions may be accomplished by suspending transmissions on specific channels, gating transmissions on specific channels, reducing transmit power levels, or a combination thereof. FIG. 4 is a state diagram illustrating the operation of the mobile terminal 100 according to one embodiment of the present invention. In an active state, the mobile terminal 100 transmits a continuous or ungated pilot signal on a reverse pilot channel (R-PICH) and transmits rate control information on a reverse rate control channel. The Walsh cover is applied to the reverse rate control channel to indicate the serving base station 12 for forward link communications. The serving base station 12 signals the mobile terminal to transition to the control hold state using well-known signaling techniques. In the control hold state, the mobile terminal 100 transmits a pilot signal and applies the Walsh cover to the pilot signal to indicate the serving base station 12 for forward link communications. The pilot signal may be a gated pilot signal, or may be continuous. The term gated as used herein means that a signal is transmitted at a reduced rate, i.e., less than the full available rate. Transmission of rate control information is suspended in control hold state. The pilot signal may be transmitted on the reverse pilot channel, the reverse rate control channel, or other reverse link channel. The mobile terminal 100 transitions back to the active state to send or receive data on the traffic channel. Transition to the active state may be signaled by the base station 12 or may be initiated by the mobile terminal 100. During the control hold state, transmission of rate control information may be suspended.

In one embodiment of the invention, the mobile terminal continues transmitting the pilot signal on the reverse pilot channel and suspends transmissions on the rate control channel during the control hold state. Alternatively, the pilot signal may be generated by blanking the rate control channel, that is, replacing the rate control information with all zeros or other null data, and suspending transmission of the R-PICH. The null data transmitted on the reverse rate control channel serves as a pilot signal when transmissions on the R-PICH is gated off. The pilot signal could also be gated, i.e., transmitted at a reduced duty cycle, to further reduce transmissions during the control hold state.

Covering the pilot signal with a sector selection code provides a means for reducing interference by eliminating the necessity of transmitting on two separate channels in the control hold state. Transmission may be further reduced by gating the pilot signal in the control hold state. Further, the present invention avoids the problem of delays in returning to the active state when the reverse rate control channel is gated off by applying the sector selection coding to the gated pilot signal. The base station 12 is able to reliably detect the Walsh cover applied to the pilot signal by correlating the received pilot signal with its assigned Walsh cover. If the pilot signal is needed for other operations, such as signal time tracking, power control or channel estimation, the base station 12 can correlate the received pilot signal with a set of possible Walsh codes to despread the pilot signal. If necessary, processing of signaling messages may be delayed to allow time for despreading the pilot signal.

The present invention also provides a means for implicit signaling of the transition from the control hold state to the active state by the mobile terminal. For example, in the embodiment where the reverse pilot channel is gated off in the control hold state, the base station may detect transition from the control hold state to the active state by detecting the energy or power on the reverse pilot channel. When the base station detects energy on the reverse pilot channel, it knows that the mobile terminal has transitioned from the control hold state to the active state without any explicit signaling. In the embodiment where the rate control channel is gated off in the control hold state, the base station can detect transition from the control hold state to the active state by detecting energy on the reverse rate control channel.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. In a mobile communication system, a method of indicating a serving base station for forward link communications by a mobile terminal in a control hold state, the method comprising:
transmitting a pilot signal while in the control hold state; and
applying sector selection coding to the pilot signal while in the control hold state to indicate the serving base station selected by the mobile terminal for forward link communications.

2. The method of claim 1 wherein transmitting a pilot signal while in the control hold state comprises transmitting the pilot signal on a reverse pilot channel while in the control hold state.

3. The method of claim 2 wherein the mobile communication system is a 1xEV-DV or 1xEV-DO system and wherein the reverse pilot channel is the R-PICH.

4. The method of claim 3 further comprising discontinuing transmission on a reverse rate control channel in the control hold state.

5. The method of claim 4 further comprising resuming transmission on the reverse rate control channel upon transition to the active state from the control hold state.

6. The method of claim 5 further comprising detecting transition of the mobile terminal to the active state from the control hold state at a base station by detecting energy on the reverse rate control channel.

7. The method of claim 1 wherein transmitting a pilot signal while in a control hold state comprises transmitting the pilot signal on a reverse rate control channel while in the control hold state.

8. The method of claim 7 wherein the mobile communication system is a 1xEV-DV system and wherein the reverse rate control channel is the reverse channel quality indicator channel (R-CQICH).

9. The method of claim 4 wherein the mobile communication system is a 1xEV-DO system and wherein the reverse rate control channel is the reverse data rate request channel (DRC).

10. The method of claim 7 further comprising discontinuing transmission on a reverse pilot channel in the control hold state.

11. The method of claim 10 further comprising resuming transmission on the reverse pilot channel upon transition to the active state from the control hold state.

12. The method of claim 11 further comprising detecting transition of the mobile terminal to the active state from the control hold state at the base station by detecting energy on the reverse pilot channel.

13. The method of claim 7 further comprising replacing rate control information normally transmitted on the reverse rate control channel with null data to generate the pilot signal.

14. The method of claim 1 wherein transmitting a pilot signal while in the control hold state comprises transmitting a gated pilot signal.

15. The method of claim 1 further comprising transmitting a pilot signal on a reverse pilot channel and rate control information on a reverse rate control channel in the active state.

16. The method of claim 15 further comprising applying sector selection coding to the reverse rate control channel in the active state.

17. A mobile terminal for CDMA systems having multiple operating states, including:
an active state in which the mobile terminal transmits a pilot signal on a reverse pilot channel and rate control information on a reverse rate control channel; and
a control hold state in which the mobile terminal transmits a pilot signal covered by a sector selection code associated with a selected forward link serving sector.

18. The mobile terminal of claim 17 wherein the mobile terminal transmits the pilot signal on the reverse pilot channel in the control hold state.

19. The mobile terminal of claim 18 wherein the reverse pilot channel is the R-PICH channel in a 1xEV-DV system.

20. The mobile terminal of claim 19 wherein the mobile terminal discontinues transmissions on the reverse rate control channel in the control hold state.

21. The mobile terminal of claim 20 wherein the mobile terminal resumes transmissions on the reverse rate control channel upon transition to the active state from the control hold state.

22. The mobile terminal of claim 17 wherein the mobile terminal transmits the pilot signal on a reverse rate control channel in the control hold state.

23. The mobile terminal of claim 22 wherein the reverse rate control channel is the R-CQICH channel in a 1xEV-DV system.

24. The mobile terminal of claim 22 wherein the reverse rate control channel is the DRC channel in a 1xEV-DO system.

25. The mobile terminal of claim 22 wherein the mobile terminal discontinues transmissions on the reverse pilot channel in the control hold state.

26. The mobile terminal of claim 25 wherein the mobile terminal resumes transmissions on the reverse pilot channel upon transition to the active state from the control hold state.

27. The mobile terminal of claim 17, wherein the mobile terminal transmits a gated pilot signal in the control hold state.

28. The mobile terminal of claim 17, wherein the mobile terminal applies the sector selection code to the rate control channel in the active state.

29. A wireless communication system, comprising:
a plurality of base stations, each having a sector selection code associated therewith; and
a mobile terminal operative to select one of the base stations as a serving base station for forward link communications, and to indicate its selection in a control hold state by transmitting a pilot signal covered by a sector selection code associated with the selected base station.

30. The wireless communication system of claim 29 wherein the mobile terminal transmits the pilot signal on a reverse pilot channel in the control hold state.

31. The wireless communication system of claim 30 wherein the reverse pilot channel is the R-PICH channel in a 1xEV-DV system.

32. The wireless communication system of claim 31 wherein the mobile terminal transmits rate control information on a reverse rate control channel in an active state and discontinues transmissions on the reverse rate control channel in the control hold state.

33. The wireless communication system of claim 32 wherein the mobile terminal resumes transmissions on the reverse rate control channel upon transition to the active state from the control hold state.

34. The wireless communication system of claim 29 wherein the mobile terminal transmits the pilot signal on a reverse rate control channel in the control hold state.

35. The wireless communication system of claim 34 wherein the reverse rate control channel is the R-CQICH channel in a 1xEV-DV system.

36. The wireless communication system of claim 34 wherein the reverse rate control channel is the DRC channel in a 1xEV-DO system.

37. The wireless communication system of claim 34 wherein the mobile terminal transmits a pilot signal on a reverse pilot channel in an active state and discontinues transmissions on the reverse pilot channel in the control hold state.

38. The wireless communication system of claim 37 wherein the mobile terminal resumes transmissions on the reverse pilot channel upon transition to the active state from the control hold state.

39. The wireless communication system of claim 29 wherein the mobile terminal transmits a pilot signal on a reverse pilot channel and rate control information on a reverse rate control channel in an active state.

40. The wireless communication system of claim 39 wherein the mobile terminal applies the sector selection code to the rate control channel in the active state.

41. The wireless communication system of claim 39 wherein the base stations detect transition of the mobile terminal to the active state from the control hold state by detecting the energy on the pilot channel.

42. The wireless communication system of claim 39 wherein the base stations detect transition of the mobile terminal to the active state from the control hold state by detecting the energy on the reverse rate control channel.

43. The wireless communication system of claim 29 wherein the mobile terminal transmits a gated pilot signal in the control hold state.

44. A mobile terminal for CDMA systems having multiple operating states, comprising:
a transmitter for transmitting a pilot signal in an active state and a control hold state; and
a controller to apply a sector selection code to the pilot signal in the control hold state.

45. The mobile terminal of claim 44 wherein the mobile terminal transmits the pilot signal on a reverse pilot channel in the control hold state.

46. The mobile terminal of claim 45 wherein the reverse pilot channel is the R-PICH channel in a 1xEV-DV system.

47. The mobile terminal of claim 46 wherein the mobile terminal transmits rate control information on a reverse rate control channel in an active state and discontinues transmissions on the reverse rate control channel in the control hold state.

48. The mobile terminal of claim 47 wherein the mobile terminal resumes transmissions on the reverse rate control channel upon transition to the active state from the control hold state.

49. The mobile terminal of claim 44 wherein the mobile terminal transmits the pilot signal on a reverse rate control channel in the control hold state.

50. The mobile terminal of claim 49 wherein the reverse rate control channel is the R-CQICH channel in a 1xEV-DV system.

51. The mobile terminal of claim 49 wherein the reverse rate control channel is the DRC channel in a 1xEV-DO system.

52. The mobile terminal of claim 49 wherein the mobile terminal transmits a pilot signal on a reverse pilot channel in an active state and discontinues transmissions on the reverse pilot channel in the control hold state.

53. The mobile terminal of claim 52 wherein the mobile terminal resumes transmissions on a reverse pilot channel upon transition to the active state from the control hold state.

54. The mobile terminal of claim 44 wherein the mobile terminal transmits rate control information on a rate control in an active state and applies the sector selection code to the rate control channel in the active state.

55. The mobile terminal of claim 44 wherein the mobile terminal transmits a gated pilot signal in the control hold state.
